(19) United States
(12) Patent Application Publication
(10) Pub. No.: US 2014/0135390 A1
(43) Pub. Date: May 15, 2014

(54) Modified Platinum Compounds

(71) Applicant: Amal Ayoub, Maalot-Tarshiha (IL)

(72) Inventor: Amal Ayoub, Maalot-Tarshiha (IL)

(21) Appl. No.: 14/160,007

(22) Filed: Jan. 21, 2014

Related U.S. Application Data
(63) Continuation of application No. PCT/IL2012/050248, filed on Jul. 16, 2012.
(60) Provisional application No. 61/509,593, filed on Jul. 20, 2011.

(51) Int. Cl. C07F 15/00

(52) U.S. Cl. CPC C07F 15/0093
USPC 514/492; 556/137; 556/136

(57) ABSTRACT

Platinum compounds, modified by conjugation with thiol-containing moieties, such as cysteine or N-acetyl cystein (NAC), and pharmaceutical compositions including the modified platinum compounds. Methods for treatment of a malignancy including administering and activating the modified platinum compounds.

### FIELD OF THE INVENTION

The present invention relates to modified platinum compounds, to pharmaceutical compositions comprising them and to their use in treatment of cancer.

### BACKGROUND OF THE INVENTION

One of the most common approaches in treatment of cancer is chemoterapy in which one or more chemical substances that are toxic to cancerous cells, are administered to an individual in need thereof. Unfortunetly, the vast majority of such chemotherapeutic agents are toxic also to healthy cells causing undesireable effects to the patient.

### Platinum Compounds

Platinum drugs constitute an important class of compounds in the treatment of cancer, and have demonstrated a broad spectrum of anti-cancer activity against a variety of tumors including germ cell tumors, testicular, ovarian and bladder carcinomas, squamous cell tumors of the head and neck, esophageal cancers, small and non-small cell lung tumors, refractory non-Hodgkin's lymphomas and colon carcinomas either as single agent or in combination with other chemotherapy drugs. Platinum is used to treat 50% of all cancers (Curr Med Chem 2005, 12: 2075-94).

The discovery that platinum may be involved in inhibition of the cell division process was first suggested in 1969 by Rosenberg et al. (Nature 205, 698-699). In 1969, Rosenberg et al (Nature 222, 385-386) described platinum compounds as a new class of potent antitumour agents.

Several platinum-based anti-cancer agents are known in the art, for example, cisplatin, carboplatin and oxaliplatin. These platinum compounds react in vivo, by binding to and causing cross linking of DNA strands which ultimately triggers apoptosis (programmed cell death) and subsequently removed by phagocytosis by macrophages or other immune system components.

Cisplatin—cis-diamminedichloroplatinum(II) (CDDP)
Cisplain, represented by Formula 1:

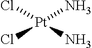

is a complex, with platinum as the central atom surrounded by two chloride atoms and two amonia molecules. As a chemotherapy drug it is used to treat various types of cancers, including sarcomas, some carcinomas (e.g. small cell lung cancer, and ovarian cancer), lymphomas, and germ cell tumors. Following administration of cisplatin, one of the chloride ligands is slowly displaced by water, in a process termed aquation. The aqua ligand in the resulting [PtCl(H₂O)(NH₃)₂]⁺ is displaced, allowing the platinum atom to bind mostly to guanine as the preferred DNA base. Subsequent to formation of [PtCl(guanine-DNA)(NH₃)₂]⁺, cross linking can occur via displacement of the other chloride ligand, typically by another guanine. Cisplatin cross links DNA in several different ways, interfering with cell division(mitosis). The damaged DNA elicits DNA repair mechanisms, which in turn activate apoptosis when repair proves impossible.

Cisplatin is also used as a radio-sensitizer in the treatment of several cancer types including head and neck malignancies as well as cervical cancer, high grade gliomas and squamous cell carcinoma of the lung.

The use of cisplatin is limited by its nephrotoxicity, neurotoxicity myelotoxicity (Cancer Treat Rev 2007, 33:9-23) and ototoxicity. The dose limiting toxicity is sensory neuropathy that occurs in more than 20% of treated patients, causing 20 frequently to either withhold treatment and or stopping of the treatment prior to the planned time. Cisplatin-induced neuropathy can persist for more than one year after the treatment ends. In addition, due to its limited solubility, Cisplatin solutions do not exceed 1 mg/ml in concentration.

Townsend et al. (2003, Drug Metabolism & Distribution, 31, 705-713), characterizes the nephrotoxic by-products of cisplatin. It is shown that pre-incubation of cisplatin with thiol containing compounds, including N-acetyl-cysteine (NAC), resulted in a transient increase in the nephrotoxicity to cisplatin. The increased toxicity is likely due to the formation of mono-platinum-mono-NAC structure.

### Oxaliplatin

Oxaliplatin, represented by Formula 2:

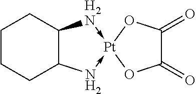

is a coordination complex that is used in cancer treatment, currently as the treatment for most gastro-intestinal malignancies. The cytotoxicity of Oxaliplatin is thought to result from inhibition of DNA synthesis in cancer cells. Main side-effects of oxaliplatin include peripheral neuropathy, fatigue and ototoxicity. Neurotoxicity is not known with certainty, but may occurs as oxalate, one of oxaliplatin's metabolites, implicated in the acute neurotoxic effects of ethylene glycol poisoning and a known chelator of both Ca and Mg, might be involved in this acute neurotoxic effect via Ca and/or Mg chelation.

U.S. Pat. No. 4,310,515 describes an injectable, stable, sterile solution of cisplatin.

U.S. Pat. No. 4,451,447 describes sterile, stable concentrated solutions of cisplatin in a solvent comprising either polyethylene glycol or methoxy polyethylene glycol and water and a nontoxic pharmaceutically acceptable source of chloride ions.

European Patent No. EP0057023 discloses diammine platinum complexes, with hydroxy-carboxylic acid or sugar phosphate, useful as antitumour agents, with decreased nephro-toxicity and higher water solubility than cisplatin.

Thiols-containing moieties, such as cysteine and modified cysteine molecules, are known chemoprotectors.

WO 99/07350 describes use of L-cysteine and/or derivatives thereof for producing a pharmaceutical composition to selectively protect non-malignant cells, and an extracorporeal method for selectively protecting non-malignant cells during a treatment set to induce the cell death of malignant cells.

WO01/80832 discloses a method of administration of a high dose of thiol-based chemoprotectant agents that markedly affects biodistribution and further protects against injury from diagnostic or therapeutic intra-arterial procedures involving a cytotoxic agent.

WO 03/045334 describes compositions used for treating undesirable effects of chemotherapy, comprising at least one and preferably two, chemoprotectants and a chemotherapeutic agent. It is demonstrated that in the disclosed compositions, NAC does not inhibit the ability of cisplatin to kill ovarian cancer cells.

U.S. Pat. No. 6,312,734 describes production of a composite having the formula: bis-(gamma-L-glutamyl)-L-cysteinyl-bis-glycine disodium salt with a platinum material such as cisplatin, preferably in the mole ratio of 3000:1, more preferably in a mole ratio of 1000:1. The composite is characterized as having a stabilized disulfide bond. Upon introduction into biological media, a longer drug half-life time is demonstrated for the disulfide form.

While the art above references disclose use of NAC for reducing the toxicity of active platinum-based compositions, none of the aforementioned publications discloses non-toxic pharmaceutical compositions comprising high concentration of attenuated platinum compounds and their use in treatment of cancer following in-situ activation at the target site. There remains an unmet need for improved anti cancer agents that will be non toxic upon administration to healthy tissues and more effective in the specific and selective elimination of cancer cells.

### SUMMARY OF THE INVENTION

The present invention provides non-toxic pharmaceutical compositions and uses thereof, comprising modified, attenuated platinum compounds which are activated at the target site. It is disclosed herein for the first time, that platinum-based compositions can be produced and administered as totally non-toxic form and can be activated to release the chemically active platinum compounds, specifically at the required time and body site.

The present invention is based in part on the discovery that toxic chemotherapeutic compounds, such as cisplatin, can be modified to significantly reduce its toxicity, by conjugation with thiol-containing moieties such as cysteine, cysteine derivatives and PEG-thiol. The modified platinum compound in the pharmaceutical compositions of the present invention is highly soluble, stable, and available at high concentrations and purity, allowing, following their activation at the desired target sites, improved effectiveness against cancer cells and decreased toxicity to normal cells. Following administration, the modified platinum compound is activated in-situ, by, for example, radiation, to release the toxic platinum molecules that selectively and specifically eradicate cancer cells at the target tissues.

In addition, to their direct activity on cancer cells, the modified platinum compounds contained in the pharmaceutical compositions of the present invention, act also as radio-sensitizers. Therefore, the non-toxic pharmaceutical compositions of the present invention may be administered in high doses and allow for enhancement of radiotherapy activity against cancer cells.

In a first aspect, the invention provides a non-toxic pharmaceutical composition comprising a stable and soluble modified metal compound which is capable of being activated to a toxic form, and optionally a pharmaceutically acceptable carrier.

According to some aspects of the present invention the metal compound is modified by conjugation with at least one thiol-containing moiety which is capable of being cleaved upon activation at the target site to render the metal compound chemically active and toxic to cancer cells.

According to particular embodiments, activation is performed by ionizing radiation applied specifically to the target site.

According to particular embodiments the modified metal compound is a metal coordination molecule or complex conjugated with at least one thiol-containing moiety to form a non-active, sulfur-containing metal compound. The sulfur-containing moiety of the modified metal is capable of being cleaved by brakeage of its chemical bond with the metal, upon activation, for example with ionizing radiation, at the target site to render the metal compound chemically active and toxic to cancer cells. According to some embodiments, the metal compound is platinum.

According to yet other embodiments, the metal compound is selected from platinum, rutherium, gold or palladium. Each possibility represents a separate embodiment of the present invention.

According to some embodiments, the modified metal coordination molecule or complex is conjugated with at least two thiol-containing moieties. According to other embodiments, the modified metal coordination molecule or complex is conjugated with at least three thiol-containing moieties. According to yet other embodiments, the modified metal coordination molecule or complex is conjugated with four thiol-containing moieties. Each possibility represents a separate embodiment of the present invention.

According to some embodiments, the pharmaceutical composition of the present invention comprises a soluble modified platinum compound in a concentration of at least 50 mM. According to other embodiments, the concentration of the modified platinum compound in the pharmaceutical composition is at least 150 mM. According to some particular embodiments, the concentration of the modified platinum compound in the pharmaceutical composition is about 50-150 mM. According to yet other embodiments, the concentration of the modified platinum compound in the pharmaceutical composition is in the range of 100-500 mM. Each possibility represents a separate embodiment of the present invention.

According to some embodiments, at least 90% of the platinum molecules contained in the pharmaceutical composition of the present invention are in the form of a modified platinum compound, namely conjugated with at least one thiol-containing moiety. According to other embodiments, at least 95%, at least 96%, at least 97%, at least 98% of the platinum molecules contained in the pharmaceutical composition are in the form of modified platinum compound. According to a particular embodiment, at least 99% of the platinum molecules contained in the pharmaceutical composition of the present invention are in the form of a modified platinum compound. Each possibility represents a separate embodiment of the present invention.

According to some embodiments, a pharmaceutical composition according to the present invention comprises less than 10% of free, unmodified platinum compound, namely platinum compound not conjugated to a thiol-containing moiety. According to other embodiments, a pharmaceutical composition according to the present invention contains less than 5%, less than 4%, less than 3%, less than 2% unmodified platinum compound. According to yet other embodiments, the pharmaceutical composition of the present invention comprises less than 1% unmodified platinum compound. According to yet other embodiments, the pharmaceutical composition of the present invention is free of unmodified, toxic platinum compound. According to other embodiments, the pharmaceutical composition of the present invention is free of non-conjugated thiol-containing moieties. Each possibility represents a separate embodiment of the present invention.

Any platinum compound that is effective as a chemotherapeutic agent may be used according to the present invention to produce the non-toxic modified platinum complex disclosed in the present invention.

According to some embodiments, modified platinum compounds according to the present invention are in cis geometry. According to other embodiments, modified platinum compounds are trans isomers. According to yet other embodiments, a pharmaceutical composition according to the present invention comprises mixture of cis and trans isomers of modified platinum or other metal compounds or complexes. According to some embodiments, the platinum complex is cisplatin. According to another embodiment, the platinum complex is oxaliplatin, transplatin, or carboplatin. Each possibility represents a separate embodiment of the invention.

According to one particular embodiments of the present invention, the pharmaceutical composition does not contain detectable amounts of free, un-conjugated, cisplatin coordinated complex.

The thiol-containing moiety of the present invention may be part of any molecule of a water soluble SH-containing compound. The term thiol-containing moiety encompasses thioxy molecule. In some embodiments, the thiol-containing moiety of the present invention is a cysteine residue or a cysteine derivative. According to a particular embodiment, the modified cysteine residue is N-acetyl-cysteine (NAC).

In other embodiments, a thiol-containing moiety is a bio-compatible polymer conjugated to thiol or to a thiol-containing moiety. According to a particular embodiment the thiol moiety is PEG-SH, PEG-Cysteine or PEG-NAC. Each possibility represents a separate embodiment of the present invention.

According to some particular embodiments, the pharmaceutical composition comprises a modified platinum molecule selected from cisplatin, transplatin, carboplatin and oxaliplatin conjugated to a thiol-containing moiety selected from NAC or Cysteine. In a particular embodiment, the pharmaceutical composition comprised cisplatin or oxaliplatin conjugated with cysteine residues or NAC residue. Each possibility represents a separate embodiment of the present invention.

Thus, a pharmaceutical composition according to the present invention comprises, according to some particular embodiments, a modified platinum compound selected from the group consisting of:

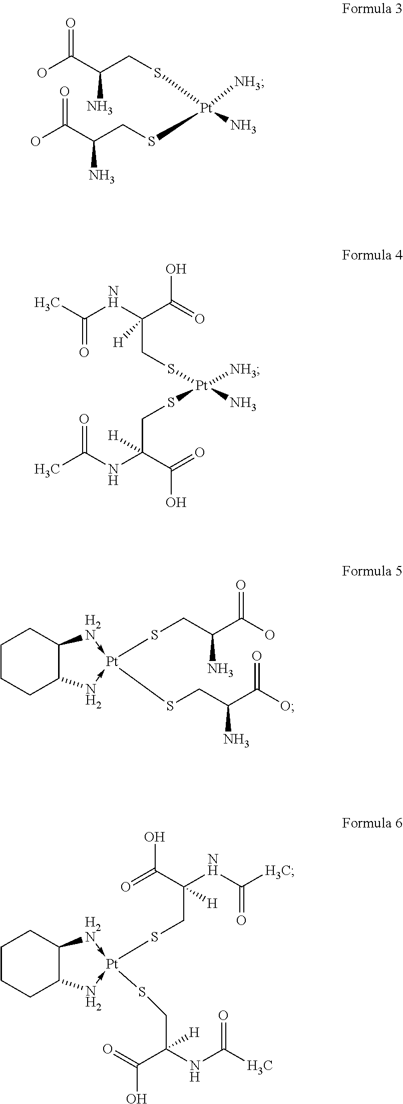

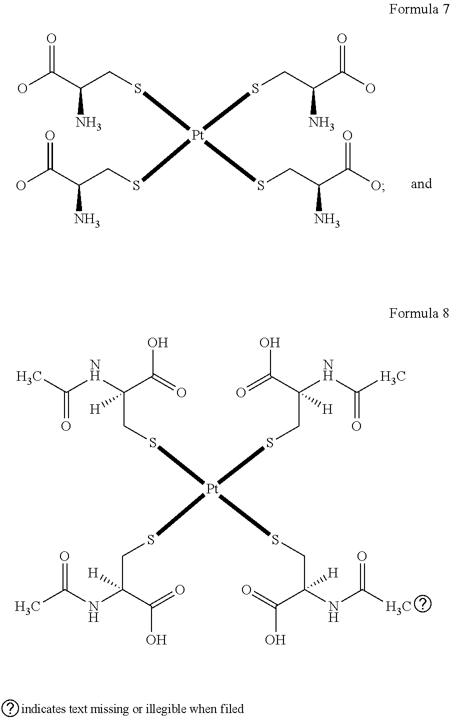

In another aspect, the invention provides a method of producing a stable, non-toxic pharmaceutical composition comprising a soluble modified platinum coordination compound, comprising a platinum molecule conjugated to a thiol-containing moiety. According to some embodiments, the method results in a composition wherein at least 90% of the platinum molecules are in the form of modified platinum compounds, namely conjugated to a thiol-containing moiety.

According to some embodiments, the method comprises incubating a thiol-containing moiety with a platinum compound in a molar ratio of at least 4:1 for at least 3 hours. According to some embodiments, the thiol-containing moiety is added to the incubation mixture in a molar excess of 5-20 times the platinum compound. According to other embodiments, the thiol-containing moiety is added to the incubation mixture in a molar excess of 5:1, 6:1, 7:1, 8:1, 9:1 or 10:1 relative to the platinum compound. According to some embodiments, the thiol-containing moiety and the platinum compound are incubated for at least 12 hours. According to a particular embodiment, the thiol-containing moiety and the platinum compound are incubated for 20-60 hours. Each possibility represents a separate embodiment of the present invention.

According to some embodiments, the pH of the reaction mixture is adjusted to a pH of 4.5-8. According to a particular embodiment, the pH of the reaction mixture is adjusted to about 7. Each possibility represents a separate embodiment of the present invention.

In a particular embodiment, the modified platinum compounds in the composition are further purified from unmodified platinum molecules so that at least 99% of the platinum compounds contained in the composition are modified.

In another aspect, the invention provides a method of treating a subject having cancer, comprising the steps of: (a) administering to the subject a non-toxic pharmaceutical composition comprising a modified platinum compound; and (b) in-situ activation.

According to some embodiments, in situ activation is performed by means of irradiation. According to some specific embodiments, irradiation is gamma or beta radiation.

According to some embodiments the pharmaceutical composition of the present invention comprises no more than 5% of unmodified platinum compound. According to other embodiments the pharmaceutical composition comprises less than 4%, less than 3%, less than 2% unmodified platinum compound. According to yet other embodiments, the pharmaceutical composition comprises less than 1% unmodified platinum compound. According to yet other embodiments, the pharmaceutical composition does not contain free, unmodified, toxic platinum compound. According to other embodiments, the pharmaceutical composition is free of non-conjugated thiol-containing moieties. Each possibility represents a separate embodiment of the present invention

According to other embodiments, the pharmaceutical composition administered to a subject in need thereof, comprises at least 50 mM, more preferably at least 150 mM of at least one modified platinum compound. According to other embodiments, the pharmaceutical composition administered comprises 100-500 mM of at least one modified platinum compound. Each possibility represents a separate embodiment of the present invention.

In-situ activation of the modified platinum compound of the present invention may be performed by applying specific conditions that will result in the cleavage or dissociation of the sulfur-containing moieties from the modified metal compound and release of thiols and chemically active metal molecules at the target site. According to some embodiments, in-situ activation is performed by applying an external or internal energy source, such as radiation. According to some particular embodiments, in-situ activation is performed by external beam radiotherapy (EBRT) or by brachytherapy.

According to some embodiments, activation is performed by means of radiation applied specifically to the target site, for example, ionizing radiation, such as gamma or X-ray irradiation.

In-situ activation may be performed concurrently or sequentially with administration of the modified platinum molecule. According to some embodiments, in-situ activation is performed at least one hour after administering the modified platinum pharmaceutical composition of the present invention.

Irradiation is administered according to techniques and protocols well know to those skilled in the art. The amount of irradiation applied depends on type of malignancy, type of anti-cancer molecule administered, administration route, age, body weight, sex, and conditions of the patient, and should be determined by the physician.

According to some embodiments of the present invention, the modified platinum compound is used as radisensitizer therefore, the amount of irradiation applied is lower than the usual amount applied in similar conditions.

In yet another aspect, the present invention provides a method of increasing the control or timing of cancer therapy, comprising administering to the subject a non-toxic pharmaceutical composition comprising a modified platinum compound followed by in-situ activation at a specific desired time or times.

The present invention further provides a method of in-situ production of activated platinum compounds for treatment of cancer, comprising: i. modifying a platinum compound to render it non-toxic; ii. administering to a subject in need of a cancer treatment a pharmaceutical composition comprising the modified, non-toxic platinum compound; and iii. in situ activation to release the toxic platinum compound.

In another aspect, the invention provides a method of treating cancer in a subject in need of such treatment comprising: (1) administering to said subject an effective amount of a pharmaceutical composition according to the invention; and (2) administering to said subject an effective amount of radiation focused at a target site; wherein steps (1) and (2) are performed either concurrently or sequentially.

According to some embodiments, said effective amount of radiation is adapted to activate said modified platinum molecule at the target site.

According to some embodiments, activation comprises converting said modified platinum molecule into a cytotoxic compound.

Further provided is the use of a pharmaceutical composition according to the present invention, comprising a modified platinum compound in high concentration and purity, for (a) treating cancer, or for (b) enhancing the radio-sensitivity of a cell population, or for (c) potentiating radiotherapy treatment; or for (d) increasing the amount of strand breaks in DNA in a cell during radiotherapy.

Pharmaceutical compositions comprising modified platinum compounds according to the present invention may be administered by any mean known in the art for administration of chemotherapeutic platinum-based agents.

The pharmaceutical compositions of the present invention may be administered inter alia by a manner such as by injection (e.g. subcutaneous, intravenous, intralesional, intra-tumoral) or any other suitable route known in the art.

The pharmaceutical composition according to the present invention may be administered to a subject in need thereof, followed by in-situ activation, as monotherapy or as an adjuvant therapy as part of a treatment regimen in conjunction with other anti-neoplastic compositions or treatments. The pharmaceutical composition according to the present invention may be administered together with other anti-neoplastic compositions or separately in a concurrent or a sequential manner.

Any type or sub-class of cancer or tumor which is treatable with chemotherapeutic agents or radiation is applicable to be treated with the pharmaceutical compositions of the present invention. According to some embodiments, cancers treated with platinum-based chemotherapeutic are preferably eligible to be treated with the pharmaceutical compositions of the invention. A non-limitative list of cancer types which may be treated with the pharmaceutical compositions of the present invention include: germ cell tumors, testicular, ovarian and bladder carcinomas, squamous cell tumors of the head and neck, esophageal cancers, small and non-small cell lung tumors, non-Hodgkin's lymphomas, breast and colon carcinomas.

In yet another aspect, the invention provides use of modified platinum compounds for preparation of medicaments for (a) treatment of cancer, or (b) enhancing the radiosensitivity of a cell population, or (c) potentiating radiotherapy treatment; or (d) increasing the amount of strand breaks in DNA in a cell during radiotherapy.

It is to be understood explicitly that the scope of the present invention encompasses analogs, variants, isomers and derivatives of the platinum compounds and thiol-containing moieties, as are known in the art, with the stipulation that these, upon conjugation, provide soluble, stable and non-toxic compositions.

Other objects, features and advantages of the present invention will become clear from the following description and drawings.

### BRIEF DESCRIPTION OF THE FIGURES

FIG. 1 demonstrates cell viability following treatment with Cisplatin and NAC-Cisplatin.

FIGS. 2A-2C depicts normalized body weight over treatment days, of mice treated with 50 (2A), 100 (2B) and 150 (2C) mg/kg of NAC-Cisplatin. Each line represents a single mouse.

### DETAILED DESCRIPTION OF THE INVENTION

The present invention provides non-toxic pharmaceutical compositions comprising high concentration of highly purified and highly soluble modified platinum coordination compound, for treatment of cancer. The use of chemotherapeutic agents based on platinum complexes is limited due to their toxicity to normal tissues. Administration of various chemoprotectants, assist in reducing toxicity but hampers the ability of the platinum-based agent to eliminate the cancerous cells. The attenuated modified platinum compounds contained in the pharmaceutical compositions of the present invention are activated in-situ to release the toxic agents, therefore, providing high doses of an active agent at the site of action with minimum deleterious effects to the healthy surrounding tissues. In addition, the modified platinum compounds act as radiosensitizers, increasing the deleterious effect of the ionizing energy on cancer cells.

The modified compounds of the present invention are produced and applied at high concentrations, stability and purity which where not achievable before.

Modified platinum compounds disclosed herein may be produced by any method known in the art to facilitate binding of a thiol-containing moiety to a platinum complex. For example, the modified compounds may be produced by incubating a platinum complex with a thiol-containing moiety for 3-60 hours in a reaction mixture adjusted to a pH of about 4.5-8.

The modified platinum compounds of the invention may be alternatively synthesized by reacting aqueous solution of Potassium tetrachloroplatinate(II)

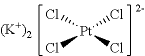

with at least one thiol-containing moiety. Preferably, two or four of the Chloride groups of the platinum tetrachloroplatinate are replaced by a sulfor-containing moiety.

### Definitions

The terms “platinum compound” and “platinum complex” according to the present invention interchangeably refer to anti cancer platinum coordination complex having either cis or trans geometry. A platinum coordination complex is a platinum atom (Pt) bonded to a surrounding array of same or different molecules or anions, which are in turn are known as ligands or complexing agents. A platinum compound or complex according to the present invention comprises a platinum atom bonded to one, two, three or four identical or different ligands. According to some embodiments, the platinum atom is bonded with two or four identical ligands.

Platinum derivatives are also included within this term according to the present invention. Non-limiting examples of platinum compounds which may be used in accordance with the present invention include cisplatin, carboplatin and oxaliplatin, or derivatives thereof or combinations thereof. Non-limiting examples of derivatives include conventional platinum coordination compounds in which the Pt atom is replaced by other metal such rutherium, gold or palladium Other examples include: (CPA)2Pt(DOLYM) and (DACH)Pt(DOLYM) cisplatin (Choi et al., Arch. Pharmacol Res. 22(2): 151-156, 1999), Cis-(PtCl2(4,7-H-5-methyl-7-oxo)1,2,4(triazolo(1,5-a)pyrimidine)2) (Navarro et al., J. Med. Chem. 4i(3):332-338, 1998), (Pt(cis-1,4-DACH)(trans-Cl2)(CBDCA)) &#8226; MeOH cisplatin (Shamsuddin et al., Inorg. Chem. 36(25):5969-5971, 1997), 4-pyridoxate diamine hydroxy platinum (Tokunaga et al., Phann. Sci. 3(7):353-356, 1997), Pt(II) &#8226; Pt(II) (Pt2(NHCHN(C(CH2)(CH3)))4) (Navarro et al., Inorg. Chem. 35(26)7829-7835, 1996), 254-S cisplatin analogue (Koga et al., Neurol. Res. 15(3):244-247, 1996), trans,cis-(Pt(0Ac)2h(en)) (Kratochwil et al., J. Med. Chem. 39(13):2499-2507, 1996), cis-1,4-diaminocyclohexane cisplatin analogues (Shamsuddin et al., J. Inorg. Biochem. 61 (4):291-301, 1996), 5′ orientational isomer of cis-(Pt(NH3)(4-aminoTEMP-O){d(GpG)}) (Dunham &amp; Lippard, J. Am. Chem. Soc. 117(43): 10702-12, 1995), chelating diamine-bearing cisplatin analogues (Koeckerbauer &amp; Bednarski, J. Pharm. Sci. S4(7):819-23, 1995), (ethylenediamine)platinum(II) complexes (Pasini et al., J. Chem. Soc, Dalton Trans. 4:579-85, 1995), CI-973 cisplatin analogue (Yang et al., Int. J. Oncol. 5(3):597-602, 1994), cis-diamminedichloroplatinum(II) and its analogues cis-1,1-cyclobutanedicarbosylato(2R)-2-methyl-1,4-butanediam-mineplatinum(H) and cis-diammine(glycolato)platinum (Claycamp &amp; Zimbrick, J. Inorg. Biochem., 26(4):257-67, 1986; Fan et al. Cancer Res. 48(11):3135-9, 1988; Heiger-Bernays et al. Biochemistry 29(36):8461-6, 1990; Kikkawa et al, J. Exp. Clin. Cancer Res. 72(4):233-40, 1993; Murray et al. Biochemistry 37(47): 11812-17, 1992; Takahashi et al. Cancer Chemother. Pharmacol. 33(1):31-5, 1993), cis-amine-cyclohexylamine-dichloroplatinum(II) (Yoshida et al, Biochem. Pharmacol. 48(A):193-9, 1994), gem-diphosphonate cisplatin analogues (FR 2683529), (meso-1,2-bis(2,6-dichloro-4-hydroxyplenyl)ethylenediamine) dichloroplatinum(II) (Bednarski et al, J. Med. Chem. 35(23):4479-85, 1992), trans-diamminedichloroplatinum(II) and cis-(Pt(NH3)2(N3-cytosine)CI) (Belton &amp; Lippard, Biophys. Chem. 35(2-3): 179-88, 1990), 3H-cis-1,2-diaminocyclohexanedichloroplatinum(II) and 3H-cis-1,2-diaminocyclohexanemalonato-platinum(II) (Oswald et al. Res. Commun. Chem. Pathol. Pharmacol. 54(I):41-58, 1989), diaminocarboxylatoplatinum (EPA 296321), aminoalkylaminoanthraquinone-derived cisplatin analogues (Kitov et al, Eur. J. Med. Chem. 23(4):381-3, 1988), spiroplatin, carboplatin, iproplatin and JM40 platinum analogues (Schroyen et al., Eur. J. Cancer Clin. Oncol. 24(8): 1309-12, 1988), bidentate tertiary diamine-containing cisplatinum derivatives (Orbeli et al., Inorg. Chim. Acta 752(2): 125-34, 1988), platinum(II), platinum(IV) (Liu &amp; Wang, Shandong Yike DaxueXuebao 2¥(1):35-41, 1986), cis-diammine(1,1-cyclobutanedicarboxylato-)platinum(II) (carboplatin, JM8) and ethylenediamine-malonatoplatinum(II) (JM40) (Begg et al., Radiother. Oncol. 9(2): 157-65, 1987), JM8 and JM9 cisplatin analogues (Harstrick et al., Int. J. Androl. 10(1); 139-45, 1987), (NPr4M(PtCL4)XiS—(PtCl2—(NH2Me)2)) (Brammer et al., J. Chem. Soc, Chem. Commun. 5:443-5, 1987), aliphatic tricarboxylic acid platinum complexes (EPA 185225), cis-dichloro(amino acid)(tert-butylamine)platinum(II) complexes (Pasini &amp; Bersanetti, Inorg. Chim. Acta 107(A):259-67, 1985), Polynuclear Platinum BBR3464, BBR3571, and BBR3610 (Billecke C. et al., Neuro-Oncol 8(3):215-26, 2006).

It should be understood that combinations of two or more anti-cancer agents can be used in accordance with the present invention as long as at least one of the anti-cancer agents is a modified platinum compound comprising at least one thiol-containing moiety.

The term “thiol-containing moiety” refers to a molecule of water soluble organic SH-containing compound. The term encompass, according to the present invention, also thioxy molecules and a molecule, containing at least one disulfide bond which under appropriate conditions may be reduced to thiol-containing moieties. Thiol-containing moieties encompass, for example cyteine and modified cysteine residues, such as: cysteine; homocysteine; cystathione; cysteamine; N-acetylcysteine; glutathione; glutathione ethylester; glutathione diethylester; glutathione triethylester; cysteamine; N,N′-diacetyl-L-cystine (DiNAC); 2(R,S)-D-ribo-(1′,2′3′,4′-tetrahydroxybutyl)-thiazolidine-4(R)-carboxylic acid (RibCys); 2-alkylthiazolidine 2(R,S)-D-ribo-(1′,2′,3′,4′-tetrahydroxybutyl)thiazolidine (RibCyst); 2(R,S)-D-gluco-(1′,2′,4′,5′-Tetrahydroxypentyl-3′-O-D-galactopyranosyl)thiazolidine-4(R)-carboxylic acid (ss-LactCys); 2(R,S)-D-gluco-(1′,2′,4′,5′-Tetrahydroxypentyl-3′-O-a-D-galactopyranosyl) thiazolidine-4(R)-carboxylic acid (a-LactCys); 2(R,S)-D-gluco-(1′,2′,3′,4′-Tetrahydroxypentyl-5′-O-a-D-galactopyranosyl) thiazolidine-4(R)-carboxylic acid (MeliCys); 2(R,S)-D-gluco-(1′,2′,4′,5′-Tetrahydroxypentyl-3′-O-a-D-glucopyranosyl)thiazolidine-4(R)-carboxylic acid (MaltCys); 2(R,S)-D-gluco-(1′,2′,4′,5′-Tetrahydroxypentyl-3′-O-P-D-glucopyranosyl)thiazolidine-4(R)-carboxylic acid (CellCys); and 2-oxo-L-thiazolidine-4-carboxylic acid (OTCA).

Any isomeric, geometric or tautomeric form of any of the thiol-containing moieties disclosed herein can be used in the invention.

A “modified platinum compound” according to the present invention designates a platinum molecule or complex which was conjugated with at least one thiol-containing group to form a platinum molecule containing at least one sulfur group.

The terms “cancer”, tumor” and “malignancy” as used herein in reference to a disease or condition, refers to any type of cancer which is suitable for treatment with the comp.

The singular forms “a”, “and”, and “the” include plural referents unless the context clearly dictates otherwise. Thus, for example, reference to “a molecule” includes a plurality of such molecules and reference to “the reagent” includes reference to one or more reagents and equivalents thereof known to those skilled in the art, and so forth.

The term “non-toxic composition” or “non-toxic pharmaceutical composition” as used herein refer to a composition comprising modified platinum (or other metal) compound or complex, which upon application to living cells, do not result in significant killing of the cells, compared to a similar composition comprising same amount of non-modified platinum molecule or complex. For example, in an in-vitro model using murine breast cancer cells EMT-6, a composition containing 50 M of modified cisplatin results in 100% cell viability, in comparison to a composition comprising non-modified cisplain which results in 0% cell-viability (100% killing) at the same concentration.

### Pharmacology

The molecules of the present invention as active ingredients are dissolved, dispersed or admixed in an excipient that is pharmaceutically acceptable and compatible with the active ingredient as is well known. Suitable excipients are, for example, water, saline, phosphate buffered saline (PBS), dextrose, glycerol, ethanol, or the like and combinations thereof. Other suitable carriers are well known to those skilled in the art. In addition, if desired, the composition can contain minor amounts of auxiliary substances such as wetting or emulsifying agents, as well as pH buffering agents.

In such pharmaceutical and medicament formulations, the active agent is preferably utilized together with one or more pharmaceutically acceptable carrier(s) and optionally any other therapeutic ingredients. The carrier(s) must be pharmaceutically acceptable in the sense of being compatible with the other ingredients of the formulation and not unduly deleterious to the recipient thereof. The active agent is provided in an amount effective to achieve the desired pharmacological effect, as described above, and in a quantity appropriate to achieve the desired daily dose.

Suitable physiologically acceptable carriers are described, for example, in Remington's Pharmaceutical Sciences (Remington's Pharmaceutical Sciences, Mack Publishing Company, Easton, Pa., USA) or Handbook of Pharmaceutical Additives (compiled by Michael and Irene Ash, Gower Publishing Limited, Aldershot, England). On this basis, the compositions include, albeit not exclusively, solutions of the substances in association with one or more pharmaceutically acceptable carrier or diluents, and may be contained in buffered solutions with a suitable pH and/or be iso-osmotic with physiological fluids.

The pharmaceutical composition of this invention may be administered by any suitable means, such as orally, topically, intranasally, subcutaneously, intramuscularly, intravenously, intra-arterially, intraarticulary, intralesionally or parenterally. Ordinarily, intravenous (i.v.), intraarticular, topical or parenteral administration will be preferred.

The compositions and formulations of the present invention are administered in amounts and at frequencies sufficient to treat cancer. A subject's progress can be determined by measuring and observing changes in the concentration of cancer markers; by measuring the actual size of the tumor over time and/or by determining any other relevant clinical markers which are well-known in the art. The determination, measurement, and evaluation of such characteristics and markers associated with clinical progress are known to those of ordinary skill in the art.

Any amount of a pharmaceutical composition can be administered to a subject. The dosages will depend on many factors including the mode of administration, the type of the anticancer agent and irradiation used and the age of the subject. It will be apparent to those of ordinary skill in the art that the therapeutically effective amount of the molecule according to the present invention will depend, inter alia upon the administration schedule, the unit dose of molecule administered, whether the molecule is administered in combination with other therapeutic agents, the immune status and health of the patient, the therapeutic activity of the molecule administered and the judgment of the treating physician. As used herein, a “therapeutically effective amount” refers to the amount of a molecule required to alleviate one or more symptoms associated with a disorder being treated over a period of time.

The appropriate dosage of a molecule of the present invention may vary depending on the administration route, type of molecule, age, body weight, sex, or conditions of the patient, and should be determined by the treating physician. Various considerations in arriving at an effective amount are described, e.g., in Goodman and Gilman's: The Pharmacological Bases of Therapeutics, 8th ed., Pergamon Press, 1990; and Remington's Pharmaceutical Sciences, 17th ed., Mack Publishing Co., Easton, Pa., 1990.

The cancers amendable for treatment by the pharmaceutical compositions of the present invention include, but not limited to, carcinoma, lymphoma, blastoma, sarcoma, and leukemia or lymphoid malignancies. More particular examples of such cancers include squamous cell cancer, lung cancer (including small-cell lung cancer, non-small cell lung cancer, adenocarcinoma of the lung, and squamous carcinoma of the lung), cancer of the peritoneum, hepatocellular cancer, gastric or stomach cancer (including gastrointestinal cancer), pancreatic cancer, glioblastoma, cervical cancer, testicular cancer, ovarian cancer, liver cancer, bladder cancer, hepatoma, breast cancer, colon cancer, colorectal cancer, endometrial or uterine carcinoma, salivary gland carcinoma, kidney or renal cancer, liver cancer, prostate cancer, vulval cancer, thyroid cancer, hepatic carcinoma and various types of head and neck cancer, as well as B-cell lymphoma (including low grade/follicular non-Hodgkin's lymphoma (NHL); small lymphocytic (SL) NHL; intermediate grade/follicular NHL; intermediate grade diffuse NHL; high grade immunoblastic NHL; high grade lymphoblastic NHL; high grade small non-cleaved cell NHL; bulky disease NHL; mantle cell lymphoma; AIDS-related lymphoma; and Waldenstrom's Macroglobulinemia); chronic lymphocytic leukemia (CLL); acute lymphoblastic leukemia (ALL); Hairy cell leukemia; chronic myeloblastic leukemia; and post-transplant lymphoproliferative disorder (PTLD), as well as abnormal vascular proliferation associated with phakomatoses, edema (such as that associated with brain tumors), and Meigs' syndrome. Preferably, the cancer is selected from the group consisting of colon, kidney, adrenocortical and hepatocellular cancers; breast cancer, Acute Myelogenous Leukemia (AML), Chronic lymphocitic leukemia (CLL), pro-lymphocitic leukemia, oesophagal carcinoma, non-small-cell lung cancers, soft-tissue sarcomas and osteosarcomas.

### Irradiation

Irradiation (also called radiation therapy or radiotherapy comprises the use of ionizing radiation to eliminate cancer cells and shrink tumors. Radiation therapy can be administered externally via external beam radiotherapy (EBRT) or internally via brachytherapy. Thus, radiation therapy is the medical use of ionizing radiation as part of cancer treatment to control the growth of malignant cells. Most common cancer types can benefit from a combination of radiotherapy and chemotherapy. Radiotherapy works by destroying the cancer cells at the treated area (by irreparably damaging their DNA and by the induction of apoptosis followed by their removal by phagocytosis by macrophages or other immune system components).

Ionizing radiation consists of subatomic particles or electromagnetic waves that are energetic enough so as to detach electrons from atoms or molecules, thus ionizing them. The occurrence of ionization depends on the energy of the impinging individual particles or waves, and not on their number. An intense flood of particles or waves will not cause ionization if these particles or waves do not carry enough energy to so as be ionizing. Roughly speaking, particles or photons with energies above a few electron volts (eV) are considered ionizing. Electrons, x rays, gamma rays or atomic ions may be used in radiation therapy to treat malignant tumors (cancer).

Radiotherapy treatment can cure cancers and can also reduce the chance of a cancer relapse post surgical intervention. It may be used to reduce cancer symptoms. Radiation therapy is commonly applied to the cancerous tumor. The radiation fields may also include the draining of lymph nodes if they are clinically or radiologically involved with the tumor or if there is a potential risk of subclinical malignant spread. It is necessary to include a margin consisting of the normal surrounding tissue around the tumor so as to allow for uncertainties in daily set-up and internal tumor motion. These uncertainties can be caused by internal movement (for example, respiration and bladder filling) and movement of external skin marks relative to the tumor position as well as nodal or local spreading of malignant cells. To spare normal healthy tissues (such as skin or organs through which radiation must pass in order to treat the tumor), shaped radiation beams are conventionally aimed from several angles of exposure to intersect at the tumor, providing a much larger absorbed dose there than in the surrounding, healthy tissue.

There are different types of radiotherapy machines, which work in slightly different ways. The number and duration of the radiotherapy sessions depend on the type of cancer and where it is located in the body. Superficial skin cancer may require only few short treatments, whereas a deep-seeded cancer in the body may require more prolonged treatment schedule. Patients usually receive external radiotherapy in small doses—each dose is called a fraction—usually during five consecutive days, so that normal tissue may recover from the treatment during off days. Accordingly, in an embodiment, the compositions of the present invention are administered daily prior to radiotherapy. The time of administration will depend on the specific formulation and on the time necessary for the modified platinum compound to reach the target cells. The time of administration will be chosen so as to provide the optimal concentration of anti-cancer agent at the time of irradiation at the judgment of the treating physician.

External beam radiotherapy (EBRT), or teletherapy is the most common form of radiotherapy. The patient sits or lies on a couch and an external source of radiation is pointed at a particular part of the body. External beam radiotherapy directs the radiation at the tumour from outside the body.

Brachytherapy, also known as internal radiotherapy, sealed source radiotherapy, curietherapy or endocurietherapy, is a form of radiotherapy where a radiation source is placed inside or next to the area requiring treatment.

Brachytherapy is commonly used as an effective treatment for cervical, prostate, breast, and skin cancer and can also be used to treat tumors in many other body sites. Brachytherapy can be used alone or in combination with other therapies such as surgery, External Beam Radiotherapy (EBRT) and chemotherapy.

### Radiosensitizers

Radiosensitizers make cancer cells more sensitive to the effects of radiation therapy. The modified platinum compounds of the present invention are activated by irradiation but also serve as radiosensitizers. When irradiated an anti-cancer agent which is located on or in the proximity of the DNA, cause an increase in single and double strand breaks in the DNA, a lethal type of damage, as compared to that caused by the anti-cancer agent alone or by radiation alone. Other radiosensitizers may be used in combination with the modified platinum compounds of the present invention. Non-limiting examples of metal radiosensitizers that could be used in accordance with the compounds of the present invention include metals, preferably inert metals such as gold, iridium, osmium, palladium, radium, zinc, chromium, copper, silver, cobalt, nickel and ruthenium. The greater the atomic number, the better is the interaction with radiation. Nanoparticles made of an inert metal may be also used as radiosensitizers.

In a specific embodiment, the composition of the present invention may comprise additional elements for increasing the biocompatibility of the metal particles and modified platinum compounds used. Non-limiting examples of such elements include elements of the class of halogens such as bromide or iodine.

### EXAMPLES

The following examples are presented in order to more fully illustrate certain embodiments of the invention. They should in no way, however, be construed as limiting the broad scope of the present invention. One skilled in the art can readily devise many variations and modifications of the principles disclosed herein without departing from the scope of the present invention.

### Example 1

### Preparation of Pharmaceutical Composition Comprising Modified Cisplatin

Modified Cisplatin was prepared by mixing 813 mg NAC with 100 mg of Cisplatin at a ratio of 15:1. 5 ml Saline was added to the mixture, the solution was then vortexed and stirred under gentle stirring for about 2 hours, HCl was added to the solution to adjust the pH to >4.5 followed by incubation for 48 hours.

The Final product in the form of a yellow solution contained more than 95% of soluble cisplatin conjugated to NAC.

### Example 2

### Modification of Cisplatin and Oxaliplatin Using Cysteine or NAC Modification of Cisplatin

Incubation of either Cysteine (Cys) or N-acetyl cysteine (NAC) with Cisplatin in an aqueous solution results in the formation of Cisplatin modified by Cys/NAC. The sulfur of the thiol group of NAC attack the Cl⁻ ions on the Cisplatin by means of nucleophilic attack, the new structure of the modified cisplatin is depicted in the following formulae:

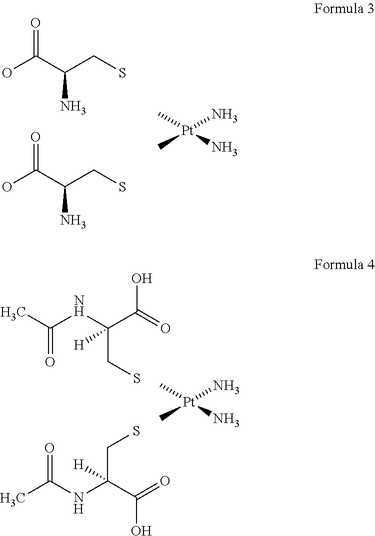

### Modification of Oxaliplatin

Incubation of either Cysteine (Cys) or N-acetyl cysteine (NAC) with Oxaliplatin in an aqueous solution results in the formation of Oxaliplatin modified by Cys/NAC. The sulfur of the thiol group of NAC attack the oxalate ligand on the Oxaliplatin by means of nucleophilic attack, the new structure of the modified Oxaliplatin is depicted in the following formulae:

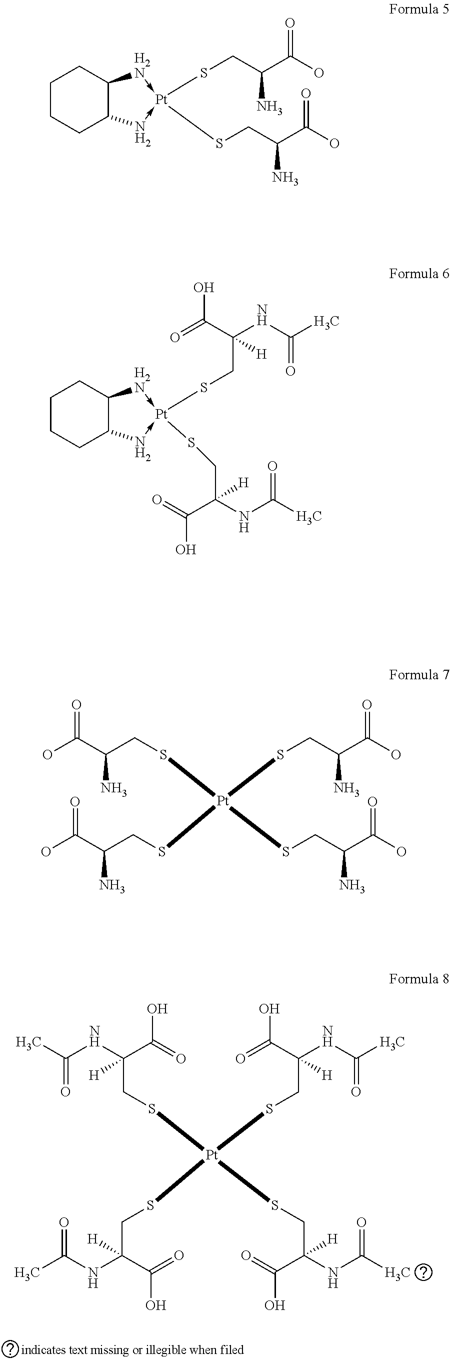

### Example 3

### Preliminary In Vitro Study

A murine breast cancer cells EMT-6 (0.5*10⁶ cells/plate) were plated and grown in Dulbecco's Modified Eagle Medium (DMEM) supplemented with 10% FBS, 2% L-Glutamine Solution (200 mM), 2% Pen-Strep Solution (Biological Industries), and 4.5 m/l D-Glucose under regular growth conditions: 5% CO₂, and 37.6° C.

Aqueous solutions of modified Cisplatin at final concentrations of 1 μM, 50 μM and 100 μM, prepared according to the procedure described above, were added to the cultured cells for an incubation period of 48 hours at 5% CO₂, and 37.6° C. Control cells and cells treated with non-modified Cisplatin at the same concentrations were similarly cultured and maintained.

After the incubation time, cells were washed with PBS (3 times), harvested using Trypsin-EDTA solution (Biological Industries), and the number of viable cells was counted under microscope using a microscope counting chamber (Hemocytometer).

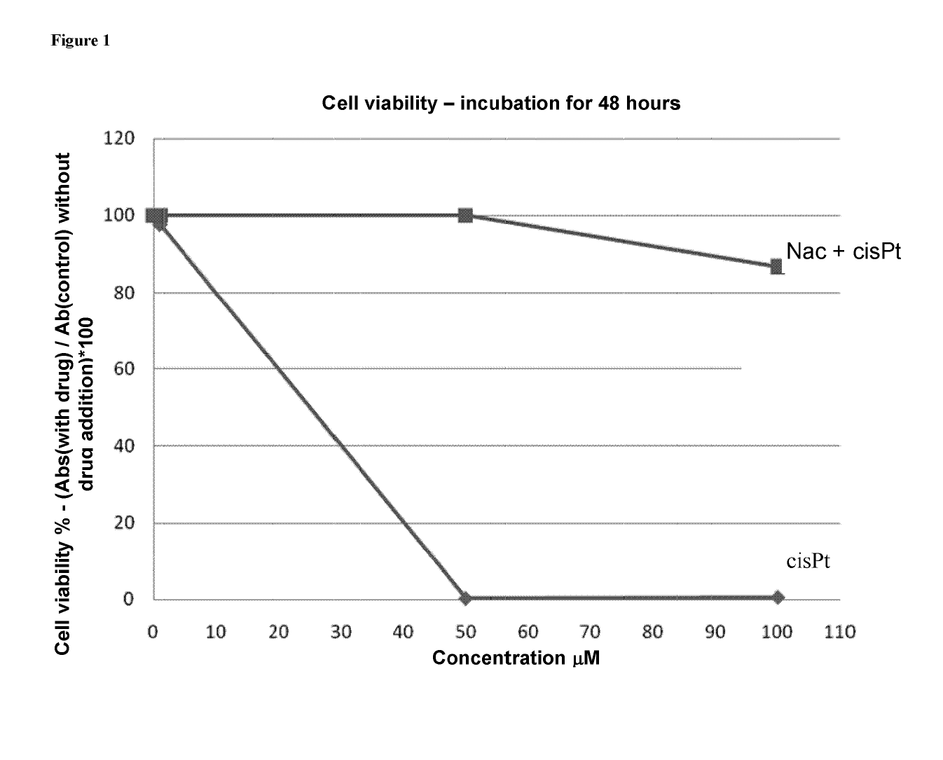

FIG. 1 plots the measurement of cell viability vs. the concentrations of Cisplatin or NAC-Cisplatin used. As can be seen, the anti cancer activity of unmodified cisplatin caused a dose-dependent reduction in the cells

In contrast, modified cisplatin with NAC was found to be non toxic to the cells. Incubation of the cells with different concentration of the modified Cisplatin did not affect the cell division maintaining cell viability at 90%.

Without wishing to be bound to any theory, it is suggested that at a concentration of 100 μM, traces of non modified cisplatin may have caused the slight toxicity to the cells compared to the control group.

### Example 4

### Determining Maximum Tolerated Dose of ME2 Dosed Intraperitoneally in Female Nude Mice

Procedures:

15 CR female NCr nu/nu mice aged 8-12 weeks are used. Mice were treated as summarized in the table below:

TABLE 1
Drugs and treatment schedule for determining maximum tolerated
dose of ME2 in female nude mice:

Drug/Testing Agent

| Group | N | Agent | mg/kg | Route | Schedule |
|---|---|---|---|---|---|
| 1 | 5 | ME2 | 50 | ip | 5/2/5 |
| 2 | 5 | ME2 | 100 | ip | 5/2/5 |
| 3 | 5 | ME2 | 150 | ip | 5/2/5 |

ME2 = Formulation of Cisplatin modified with NAC.

Dosing volume=10 mL/kg (0.200 mL/20 g mouse).Volume was adjusted accordingly for body weight

Mice were observed for treatment-related reactions: clinical signs and weight loss for 26 days.

No mortality occurred in neither of the animals treated with the modified cisplatin prior to the scheduled termination, carried out 26 days post-dosing.

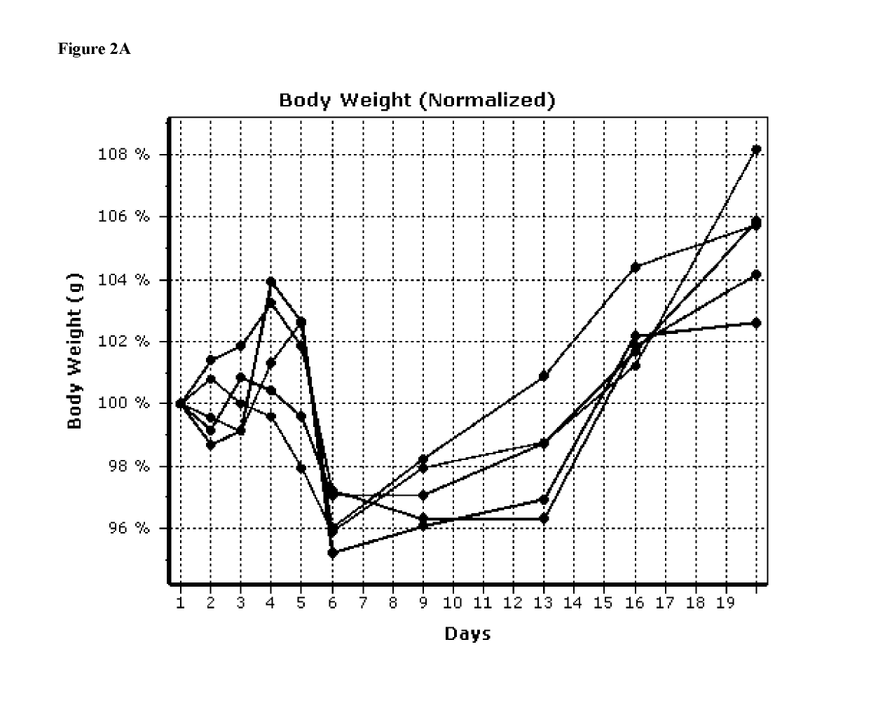

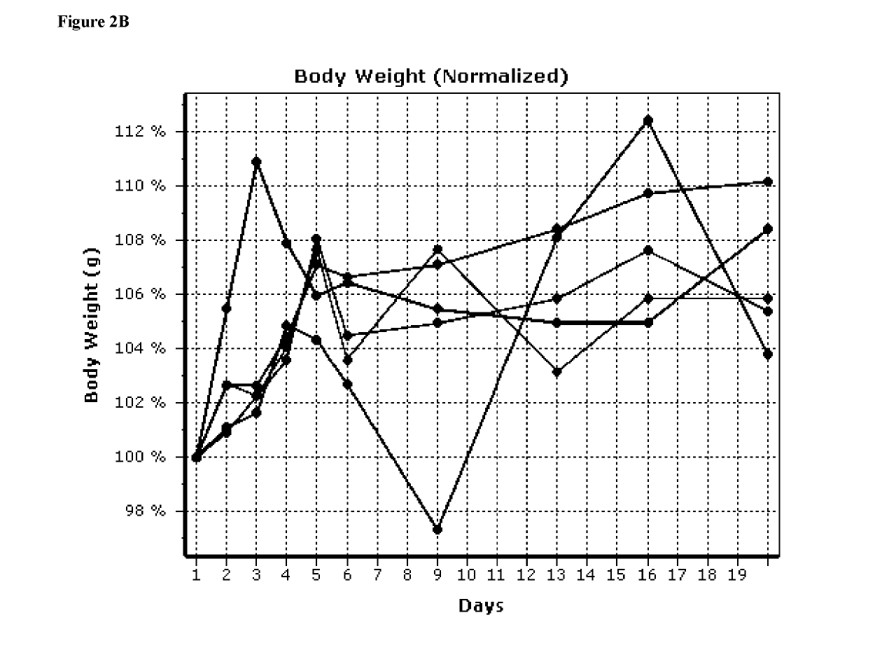

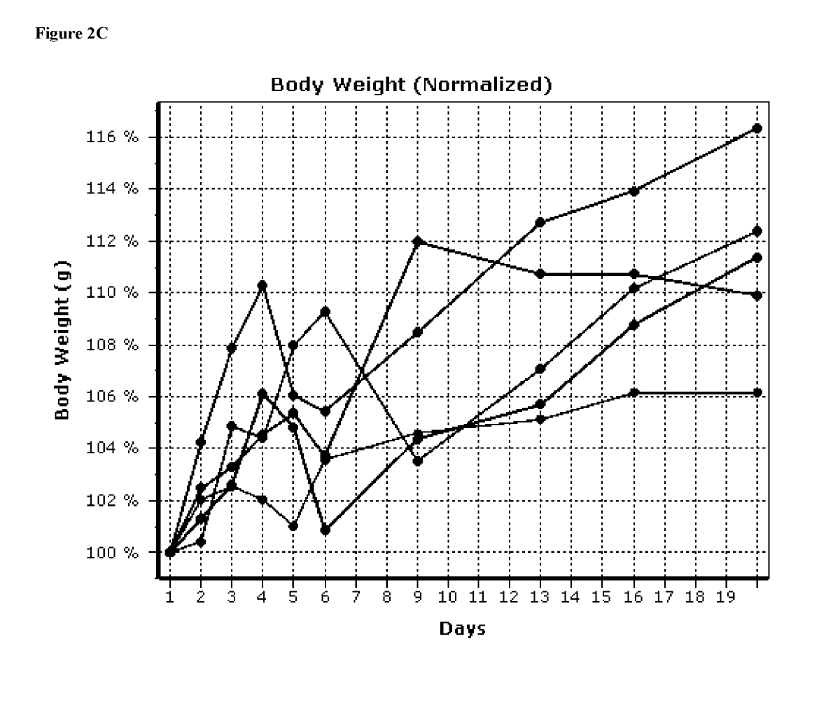

As demonstrated in FIGS. 2A-2C, there was no significant loss of body weight in any of the treated animals even with the high doses of modified cisplatin compound, indicating that the composition administered is non-toxic and does not contain considerable amounts of free cisplatin. It should be noted that due to their insolubility/toxicity it is not possible to apply comparable concentrations of free cisplatin to animals. No change in the clinical signs and well-being of the animals were observed.

### Example 5

### Determining Efficacy of Irradiation in Combination with the Pharmaceutical Composition ME2 in H460 NSCLC Xenograft Model in Female Nude Mice

Procedures:

Forty CR female NCr nu/nu mice of 8-12 weeks old are implanted at the lower back with 1×10⁷ H460 tumor cells in a volume of 0.2 mL/mouse.

When tumors reach an average size of 100-150 mg the animals are paired, and treatment start.

Four groups of 10 animals in each group are treated summarized in the table below:

TABLE 2
Drugs and treatment schedule of ME2 in H460 NSCLC xenograft model:

| | | 1 Drug/Testing Agent | | | | 2 Drug/Testing Agent | | | |
|---|---|---|---|---|---|---|---|---|---|
| Group | N | Agent | mg/kg | Route | Schedule | Agent | Gy/animal | Route | Schedule |
| 1* | 10 | vehicle | — | ip | 5/2/5 | — | — | — | — |
| 2 | 10 | ME2 | 150 | ip | 5/2/5 | — | — | — | — |
| 3 | 10 | Radiation | 2* | topical | 5/2/5 | — | — | — | — |
| 4 | 10 | ME2 | 150 | ip | 5/2/5 | Radiation | 2 | topical | 5/2/5 |

*control group

Animals are monitored as a group. The endpoint of the experiment is a mean tumor size in the control group of 2000 mm³ or the completion of 21 days, whichever comes first. Upon reaching the endpoint, all the animals are euthanized.

ME2=Formulation of Cisplatin modified with NAC.

Dosing volume=10 mL/kg (0.200 mL/20 g mouse).

Animals are irradiated between 1 and 2 hr post ME2, Necropsy is performed to all animals

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1. A non-active pharmaceutical composition comprising:
at least one soluble modified platinum compound in a non-active form, the at least one soluble modified platinum compound being modified by conjugation with at least one thiol-containing moiety;
wherein the at least one soluble modified platinum compound is being re-activated in-situ to the active form by applying ionizing radiation to a target site; and
wherein upon application of the ionizing radiation to the target site, the at least one thiol-containing moiety is cleaved to render the platinum compound active.

2. The pharmaceutical composition of claim 1, further comprising a pharmaceutically acceptable carrier.

3. The pharmaceutical composition of claim 1, wherein the radiation is internal radiation or external radiation.

4. The pharmaceutical composition of claim 1, wherein the composition includes at least 50 mM of modified platinum compound.

5. The pharmaceutical composition of claim 1, wherein the composition includes less than 5% of unmodified platinum compound.

6. The pharmaceutical composition of claim 1, wherein the platinum compound is selected from a group consisting of cisplatin, oxaliplatin, carboplatin and a combination thereof.

7. The pharmaceutical composition of claim 1, wherein the thiol-containing moiety is a cysteine residue.

8. The pharmaceutical composition of claim 7, wherein the thiol-containing moiety is an N-acetyl-cysteine (NAC) residue.

9. The pharmaceutical composition of claim 1, wherein the thiol-containing moiety comprises a biocompatible polymer.

10. The pharmaceutical composition of claim 9, wherein the thio-containing moiety is selected from the group consisting of: PEG-SH, PEG-cysteine, and PEG-NAC.

11. The pharmaceutical composition of claim 1, wherein the platinum compound is selected from the group consisting of cisplatin, transplatin, carboplatin, oxaliplatin and a combination thereof, and the thiol-containing moiety is a cysteine residue or an NAC residue.

12. The pharmaceutical composition of claim 1, wherein the modified platinum compound is selected from the group consisting of:

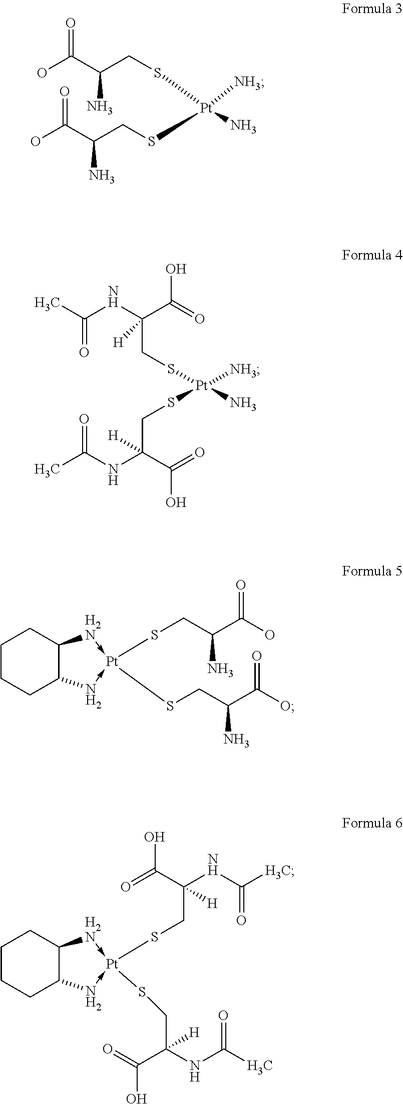

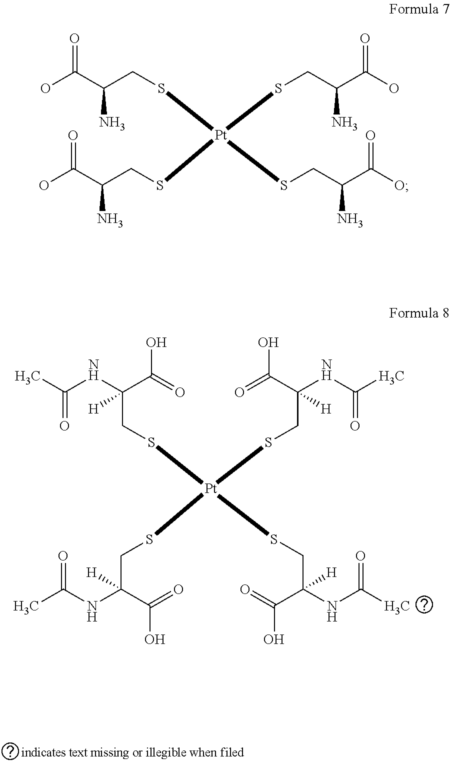

13. A method for producing a pharmaceutical composition comprising soluble modified platinum compound and less than 5% unmodified platinum molecules, the method comprising the steps of:
providing a platinum composition having platinum molecules able to be conjugated with a thiol-containing moiety; and
incubating a thiol-containing moiety with the platinum molecules in a molar ratio of at least 5:1 for at least 3 hours at a pH of 4.5-8 to form the soluble modified platinum compound comprising a platinum molecule conjugated with a thiol-containing moiety.

14. The method of claim 13 wherein the soluble modified platinum compound is purified from unmodified platinum compound.

15. A method of in-situ production of activated platinum compounds for treatment of cancer, comprising the steps of:
modifying a platinum compound to render it non-toxic;
administering to a subject in need of a cancer treatment a pharmaceutical composition comprising the modified, non-toxic platinum compound; and
conducting an in situ activation to release the toxic platinum compound within the subject.

16. A method of treating a subject having cancer, the method comprising the steps of:
administering to the subject a pharmaceutical composition according to claim 1; and
conducting an in-situ activation of the pharmaceutical composition within the subject.

17. The method of claim 16, wherein the in-situ activation of the pharmaceutical composition comprises applying irradiation specifically to a target site.

18. The method of claim 17, wherein the irradiation is performed at least one hour after the step of administering the pharmaceutical composition.

19. The method of claim 16, wherein the cancer is selected from the group consisting of: germ cell tumors, ovarian and bladder carcinomas, squamous cell tumors of the head and neck, esophageal cancers, non-small cell lung tumors and colon carcinomas.

20. A method of increasing the control or timing of cancer therapy, comprising the steps of:
administering to a subject a pharmaceutical composition according to claim 1; and
conducting an in-situ activation of the pharmaceutical composition within the subject at a specific desired time or times.
